(19) United States
(12) Patent Application Publication
(10) Pub. No.: US 2021/0238700 A1
(43) Pub. Date: Aug. 5, 2021

(54) PLANT COMPLEX FOR PRODUCING STEEL AND A METHOD FOR OPERATING THE PLANT COMPLEX

(71) Applicants: thyssenkrupp Industrial Solutions AG, Essen (DE); thyssenkrupp AG, Essen (DE)

(72) Inventors: Stefan GEHRMANN, Dortmund (DE); Nils TENHUMBERG, Dortmund (DE)

(73) Assignees: thyssenkrupp Industrial Solutions AG, Essen (DE); thyssenkrupp AG, Essen (DE)

(21) Appl. No.: 15/734,745

(22) PCT Filed: Jun. 3, 2019
(86) PCT No.: PCT/EP2019/064310

§ 371 Date: Dec. 3, 2020

(30) Foreign Application Priority Data
Jun. 7, 2018 (DE) 10 2018 209 042.4

(51) Int. Cl. C21B 5/06; C21B 7/00; C21C 5/38

(52) U.S. Cl. CPC C21B 5/06; C21B 7/002; C21B 2200/00; C21B 2100/20; C21B 2100/62; C21C 5/38

(57) ABSTRACT

A plant complex for producing steel, having a blast furnace for producing pig iron; a converter steel works for producing crude steel; a gas pipeline system for gases that occur in the production of pig iron and/or the production of crude steel; a chemical plant and/or a biotechnology plant which are/is connected to the gas pipeline system, wherein the plant complex additionally includes a biogas plant which is connected to the gas pipeline system.

The invention relates to a plant complex for producing steel and to a method for operating the plant complex.

### PRIOR ART

The plant complex for producing steel comprises a blast furnace for producing pig iron; a converter steel works for producing crude steel; a gas pipeline system for gases that occur in the production of pig iron and/or the production of crude steel; and a chemical plant and/or a biotechnology plant which are/is connected to the gas pipeline system

In the chemical plant, chemical products can be produced from the infed streams of gas which in each case contain the components of the final product. In the biotechnology plant, biochemical products can be produced from the infed streams of gas which in each case contain the components of the final product.

Pig iron is obtained in the blast furnace from iron ores, additives such as coke and other reducing agents such as coal, oil, gas, biomasses, recycled waste plastics or other substances containing carbon and/or hydrogen. CO, CO₂, and in particular hydrogen and water vapor, inevitably occur as products of the reduction reactions. Apart from the aforementioned constituents, a blast-furnace top gas which is also referred to as top gas and/or blast furnace gas, and which is drawn off from the blast-furnace process, often has a high content of nitrogen and can also contain impurities. The amount of gas and the composition of the blast-furnace top gas are dependent on the feedstock and the operating mode and are subject to fluctuations. Typically, however, blast-furnace top gas contains 35 to 60% by volume N₂, 20 to 30% by volume CO, 20 to 30% by volume CO₂, and 2 to 15% by volume H₂. Around 30 to 40 percent of the blast-furnace top gas produced in the production of the pig iron is generally used for heating up the hot air for the blast-furnace process in air heaters; the remaining amount of top gas may also be used externally in other areas of the works for heating purposes or for electricity generation.

In the converter steel works, which is arranged downstream of the blast-furnace process, pig iron is converted into crude steel. By blowing oxygen onto liquid pig iron, troublesome impurities such as carbon, silicon, sulfur and phosphorus are removed. Since the oxidation processes cause an intense development of heat, scrap as a coolant is often added in amounts of up to 25% in terms of the pig iron. Furthermore, lime is added, for forming slag, and also alloying agent. A converter gas which has a high content of CO and also contains nitrogen, hydrogen and CO2 is drawn from the steel converter. A typical converter gas composition has 50 to 70% by volume CO, 10 to 20% by volume N₂, about 15% by volume CO₂ and about 2% by volume H₂. The converter gas is either burned off or, in the case of modern steel works, captured and passed on to be used for providing energy.

The plant complex may optionally be operated in combination with a coking plant. In this case, the plant complex described at the outset additionally comprises a coke oven plant in which coal is converted into coke by a coking process. In the coking of coal into coke, a coke oven gas occurs, containing a high hydrogen content and considerable amount of CH₄. Typically, coke oven gas contains 55 to 70% by volume H₂, 20 to 30% by volume CH₄, 5 to 10% by volume N₂, and 5 to 10% by volume CO. In addition, the coke oven gas has fractions of CO₂, NH₃, and H₂S. In practice, the coke oven gas is used for example in various areas of the works for heating purposes and in the power-generating process for electricity. In addition, it is known for coke oven gas to be used together with blast-furnace top gas or with converter gas so as to produce synthesis gases. According to a method known from WO 2010/136313 A1, coke oven gas is separated into a hydrogen-rich gas stream and a residual gas stream containing CH₄ and CO, the residual gas stream being fed to the blast-furnace process and the hydrogen-rich gas stream being mixed with blast-furnace top gas and processed further into a synthesis gas. From EP 0 200 880 A2 it is known for converter gas and coke oven gas to be mixed and to be used as a synthesis gas for methanol synthesis.

In an integrated metallurgical plant that is operated in combination with a coking plant, approximately 40 to 50% of the raw gases that occur as blast-furnace top gas, converter gas and coke oven gas are used for chemical engineering processes. Approximately 50 to 60% of the gases produced are fed to the power generation plant and used for the generation of electricity. The electricity produced in the power generation plant covers the electricity demand for the production of pig iron and crude steel. Ideally, the energy balance is closed such that, apart from iron ores and carbon in the form of coal and coke as sources of energy, no further energy input is necessary and, apart from crude steel and slag, no product leaves the plant complex.

In the prior art, fluctuations in the gas pipeline system, in particular the gas supply, are problematic, this influencing the operation of chemical plants and/or biotechnology plants which are connected to the gas pipeline system.

Against this background, the invention is based on the object of improving the stability, the process management, and the sustainability of the overall process, in particular the ecological conditions of the overall process, and of in particular specifying a plant complex for producing steel by way of which it is possible to guarantee a continuous and sustainable operation of plants.

### DISCLOSURE OF THE INVENTION

This object is achieved by a plant complex for producing steel, as claimed in claim 1, and by a method for operating a plant complex, as claimed in claim 10.

The subject matter of the invention is a plant complex for producing steel, having a blast furnace for producing pig iron; a converter steel works for producing crude steel; a gas pipeline system for gases that occur in the production of pig iron and/or the production of crude steel; a chemical plant and/or a biotechnology plant which are/is connected to the gas pipeline system, wherein the plant complex additionally comprises a biogas plant which is connected to the gas pipeline system.

A further subject matter of the invention is a method for operating a plant complex which has a blast furnace for producing pig iron, a converter steel works for producing crude steel, a biogas plant for producing biogas, a gas pipeline system for gases that occur in the production of pig iron and/or the production of crude steel and/or the production of biogas, and a chemical plant and/or a biotechnology plant, wherein at least a partial amount of the biogas that occurs in the biogas plant and a partial amount of the blast-furnace top gas that occurs in the production of pig iron in the blast furnace and/or a partial amount of the converter gas that occurs in the production of crude steel are/is used as useful gas for operating the chemical plant and/or the biotechnology plant and/or the blast furnace for the production of pig iron and/or the converter steel works for the production of crude steel.

The present invention can be implemented in a plant complex for producing steel and in a method for operating a plant complex. The devices of the plant complex can be present in a single embodiment and/or in multiple embodiments.

The plant complex according to the invention for producing steel, in comparison to conventional plant complexes, has the advantages that fluctuations, in particular of gas flows and/or gas compositions in the gas pipeline system, in particular the gas supply, can be compensated for on account of the biogas plant which is connected to the gas pipeline system, and the continuous operation of the plant complex can be stabilized. Moreover, biogas, in particular also referred to as biomethane, is a gas which is produced biologically from biomass and which in particular comprises a composition of methane and carbon dioxide and which enables a sustainable operation of the plant complex and in particular improves the ecological conditions of the overall process. For example, the use of renewable energy from the electricity grid can be fully or partially reduced by way of a biogas plant in the plant complex according to the invention. Moreover, the use of natural gas can be fully or partially dispensed with on account of the biogas provided in a biogas plant, and no further pollution by so-called greenhouse gas emissions thus takes place.

The method according to the invention for operating a plant complex, in comparison to conventional methods, has the advantages that fluctuations, in particular of gas flows and/or gas compositions, can be better compensated for in the method and a continuous operation of the method can be stabilized. Moreover, the method according to the invention permits the use of biogas, in particular also referred to as biomethane, a gas which is produced biologically from biomass and which in particular comprises a composition of methane and carbon dioxide and which enables a sustainable operation of the plant complex and in particular improves the ecological conditions of the overall process. For example, with the method according to the invention for operating a plant complex, the use of renewable energy from the electricity grid can be fully or partially reduced by way of a biogas plant. Moreover, the use of natural gas can be fully or partially dispensed with on account of the biogas provided in the method according to the invention, and no further pollution by so-called greenhouse gas emissions thus takes place.

### DETAILED DESCRIPTION OF THE INVENTION

In the chemical plant, chemical products can be produced from the infed streams of gas which in each case contain the components of the final product. Chemical products may be, for example, ammonia or methanol or higher alcohols or else other hydrocarbon compounds. The performance, in particular the output, of the chemical plant is regulated as a function of the quantities of gas fed to these plants. One substantial challenge for the chemical plant is the dynamic operating mode in the case of changing plant loads, wherein the plant complex according to the invention/the method according to the invention for operating the plant complex enables the operating mode to be stabilized. The operating mode in the case of changing plant loads can in particular be implemented in that the chemical plant has a plurality of smaller units which are connected in parallel and which can be individually switched on or off, depending on the available flow of useful gas. For example, different chemical products can also be produced in one unit or a plurality of units.

For producing ammonia, a gas mixture which contains nitrogen and hydrogen in the correct ratio has to be provided. The nitrogen can be obtained from blast-furnace top gas. Blast-furnace top gas and/or converter gas and/or coke oven gas can be used as the hydrogen source, wherein additional hydrogen can be produced, in particular increased, by conversion of the CO fraction by a water-gas-shift reaction (CO+H₂O⇔CO₂+H₂). Other hydrogen sources, in particular water electrolysis, can also be considered, for example. For producing hydrocarbon compounds, for example methanol or higher alcohols, it is necessary to provide a gas mixture composed substantially of CO and/or CO₂ and Hz, that contains the components carbon monoxide and/or carbon dioxide and hydrogen in the correct ratio. Blast-furnace top gas and/or converter gas and/or coke oven gas can be used as the hydrogen source, wherein additional hydrogen can be produced by conversion of the CO fraction by a water-gas-shift reaction. Other hydrogen sources, in particular water electrolysis, can also be considered, for example. For example, converter gas can be resorted to in order for CO to be provided. Blast-furnace top gas and/or converter gas can serve as a CO₂ source, for example.

In the biotechnology plant, biochemical products can be produced from the infed streams of gas which contain in each case the components of the final product. Biological products may be, for example, alcohols (ethanol, butanol) acetone or organic acids. A biotechnology plant is in particular a fermentation plant or optionally a photo-biological plant.

A biogas plant in the context of the present invention is understood to be a plant which provides biogas from biomass. For example, biogas is produced by the microbial degradation of organic material, in particular of biomass under anoxic conditions. Microorganisms herein convert the carbohydrates, proteins and fats contained in the biomass into the primary products methane and carbon dioxide. Examples of biomass are waste materials as well as renewable raw materials of any type. For example, a biogas plant can also be a storage device, in particular a transport line, for biogas. In particular, a device for gas purification can additionally be arranged upstream of the biogas plant.

A hydrogen generation plant in the context of the present invention is understood to be a plant which provides hydrogen. For example, a hydrogen generation plant can be a pyrolysis plant, a steam reforming plant, a plant for partial oxidation, an autothermal reformer, a gasification plant, a water-gas-shift plant, or a combination thereof. For example, the biogas of a biogas plant can also be used for generating hydrogen. In particular, the generation of hydrogen can take place by electrolysis, preferably by water electrolysis, wherein the water electrolysis is expediently operated with an electric current which has been produced from renewable energy.

A plant for biosynthesis gas generation in the present invention is understood to be a plant which produces a synthesis gas from biogas. For example, a biosynthesis gas generation plant can be a steam reforming plant, a plant for partial oxidation, an autothermal reformer, or a combination thereof. In particular, a biosynthesis gas has a composition which comprises hydrogen and CO and/or CO₂. There is in particular the possibility of stabilizing the biosynthesis gas plant by feeding methane obtained from coke oven gas, under the condition that coke oven gas and renewable energy are provided in sufficient quantities.

According to one further embodiment of the invention, the plant complex additionally comprises a coke oven plant which is connected to the gas pipeline system.

In one further embodiment of the invention, the plant complex additionally comprises at least one hydrogen generation plant which is connected to the gas pipeline system.

According to one further embodiment of the invention, the plant complex additionally comprises a biosynthesis gas generation plant.

According to a further embodiment of the invention, the plant complex additionally comprises a power generation plant for electricity, wherein the power generation plant is conceived as a gas-turbine power generation plant or a gas-turbine and steam-turbine power generation plant and is operated with a gas that comprises a partial amount of the blast-furnace top gas that occurs in the production of pig iron in the blast furnace and/or a partial amount of the converter gas that occurs in the converter steel works and/or a partial amount of the biogas that occurs in the biogas plant and/or a partial amount of the coke oven gas that occurs in the coke oven plant and/or a partial amount of the biosynthesis gas that occurs in the biosynthesis gas generation plant and/or a partial amount of the hydrogen that occurs in the hydrogen generation plant.

For example, the electricity generated in the power generation plant can be fed to individual devices and/or a plurality of devices of the plant complex. The distribution of the electricity generated can in particular take place by way of power lines.

In one further embodiment of the invention, the gas pipeline system comprises at least one operatively controllable gas diverter for dividing the streams of gas that are fed to the chemical plant and/or the biotechnology plant and/or the hydrogen generation plant and/or the power generation plant and/or the coke oven plant and/or the blast furnace and/or the converter steel works and/or the biosynthesis gas generation plant. An operatively controllable gas diverter is in particular an operatively controllable gas turnout for dividing streams of gas.

According to one further embodiment of the invention, the gas pipeline system in the flow direction upstream of the at least one operatively controllable gas diverter has at least one mixing device for producing a mixed gas composed of blast-furnace top gas and/or converter gas and/or biogas and/or coke oven gas and/or hydrogen and/or oxygen and/or biosynthesis gas, and the streams of gas that are fed to the chemical plant and/or the biotechnology plant and/or the hydrogen generation plant and/or the power generation plant and/or the coke oven plant and/or the blast furnace and/or the converter steel works and/or the biosynthesis gas generation plant are able to be controlled by means of the operatively controllable gas diverter.

In the context of the present invention, a mixing device in the context of the present invention is understood to be a device which mixes gases and/or fluids with one another. A mixing device can in particular be selected from a group of a Venturi nozzle, a mixing vessel, a mixing station, a static mixer, an ejector, a pipeline T-fitting, or a combination thereof.

In one further embodiment of the invention, the plant complex additionally has an energy accumulator for covering at least part of the electricity requirement of the plant complex. For example, the energy accumulator can also be configured as a gas accumulator, in particular having a device for converting stored gas to electricity.

According to one further embodiment of the invention, the plant complex additionally has a plant for gas purification and/or gas conditioning.

In the context of the present invention, a plant for gas purification is understood to be a plant which at least partially separates those component parts of a gas that could have a disadvantageous effect in particular in terms of the efficiency in downstream process steps. Gas purification is in particular understood to be a single-stage or multiple-stage purification, in particular by mechanical sorting methods such as, for example, a separation, selected from the group of density, particle size, particle inertia, surface wettability, magnetizablity, electrical mobility, by absorptive methods, by catalytic processes, or a combination thereof.

Gas conditioning in the context of the present invention is understood to be the adjustment of gas compositions and/or of physical gas properties. For example, the proportion of the components CO, CO₂, H₂ within the streams of gas is varied in the context of the gas conditioning. The gas conditioning comprises, for example, a pressure swing adsorption for separating and enriching H₂ and/or a water-gas-shift reaction for converting CO and H₂O into H₂ and CO₂ and/or a steam reformer for converting the proportion of CH₄ into CO and hydrogen, in particular in the coke oven gas. The adjustment of a preferred gas pressure can in particular take place by way of a compressor. A temperature adjustment can be carried out in a thermal step, for example.

According to one further embodiment of the method according to the invention for operating a plant complex, the plant complex additionally comprises a coke oven plant which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant are/is used as useful gas for operating the chemical plant and/or the biotechnology plant and/or the blast furnace for the production of pig iron and/or the converter steel works for the production of crude steel and/or the coke oven plant.

In one further embodiment of the method according to the invention for operating a plant complex, the plant complex additionally comprises a hydrogen generation plant which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant are/is used as useful gas for operating the chemical plant and/or the biotechnology plant and/or the blast furnace for the production of pig iron and/or the converter steel works for the production of crude steel and/or the coke oven plant and/or the hydrogen generation plant.

According to one further embodiment of the method according to the invention for operating a plant complex, the plant complex additionally comprises a biosynthesis gas generation plant which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant and/or a partial amount of the biosynthesis gas that occurs in the biosynthesis gas generation plant are/is used as useful gas for operating the chemical plant and/or the biotechnology plant and/or the blast furnace for the production of pig iron and/or the converter steel works for the production of crude steel and/or the coke oven plant and/or the hydrogen generation plant and/or the biosynthesis gas generation plant.

According to one further embodiment of the method according to the invention for operating a plant complex, the plant complex additionally comprises a power generation plant which is connected to the gas pipeline system, wherein at least a partial amount of the blast-furnace top gas that occurs in the production of pig iron in the blast furnace and/or a partial amount of the converter gas that arises in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant and/or a partial amount of the biosynthesis gas that occurs in the biosynthesis gas generation plant are/is used as useful gas for operating the chemical plant and/or the biotechnology plant and/or the blast furnace for the production of pig iron and/or the converter steel works for the production of crude steel and/or the coke oven plant and/or the hydrogen generation plant and/or the biosynthesis gas generation plant and/or the power generation plant.

In one further embodiment of the method according to the invention for operating a plant complex, the plant complex additionally comprises a plant for gas purification and/or gas conditioning which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant and/or a partial amount of the biosynthesis gas that occurs in the biosynthesis gas generation plant are/is purified and/or conditioned.

### BRIEF DESCRIPTION OF THE DRAWINGS

The invention will be explained hereunder by means of a drawing which merely illustrates an exemplary embodiment. In a schematic manner in the drawing:

FIG. 1 shows a highly simplified block diagram of a plant complex according to the invention for producing steel.

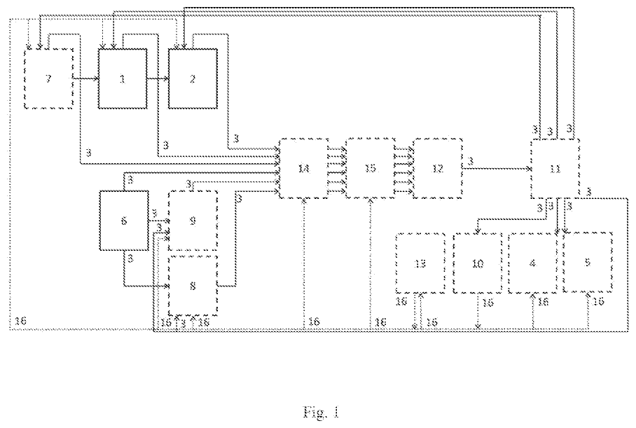

A plant complex for producing steel according to one embodiment of the invention is illustrated in FIG. 1, said plant complex having a blast furnace 1 for producing pig iron; a converter steel works 2 for producing crude steel; and a gas pipeline system 3, illustrated with solid lines, for gases that occur in the production of pig iron and/or the production of crude steel. A biogas plant 6 and a chemical plant 4 and/or a biotechnology plant 5 are connected to the gas pipeline system 3. Additionally, a coke oven plant 7 and/or a hydrogen generation plant 8 and/or a biosynthesis gas generation plant 9 are/is connected to the gas pipeline system 3. The plant complex additionally has a power generation plant 10 which is conceived as a gas-turbine power generation plant or a gas-turbine and steam-turbine power generation plant. The electric current produced by the power generation plant 10 can be distributed by way of a power line network 16, illustrated with dotted lines, to individual devices and/or a plurality of devices of the plant complex. The gas pipeline system 3 comprises an operatively controllable gas diverter 11 for dividing the streams of gas fed to the chemical plant 4 and/or the biotechnology plant 5 and/or the hydrogen generation plant 8 and/or the power generation plant 10 and/or the coke oven plant 7 and/or the biosynthesis gas generation plant 9. At least one mixing device 12 for producing a mixed gas composed of blast-furnace top gas and/or converter gas and/or biogas and/or coke oven gas and/or hydrogen and/or oxygen and/or biosynthesis gas is arranged in the flow direction upstream of the at least one operatively controllable gas diverter 11, and streams of gas that are fed to the chemical plant 4 and/or the biotechnology plant 5 and/or the hydrogen generation plant 8 and/or the power generation plant 10 and/or the coke oven plant 7 and/or the biosynthesis gas generation plant 9 are able to be controlled by means of the operatively controllable gas diverter 11. The plant complex additionally has an energy accumulator 13 for covering at least part of the electricity requirement of the plant complex. A plant for gas conditioning 15 and/or gas purification 14 is additionally arranged in the plant complex. The optional devices of the plant complex are illustrated with dashed lines.

### INDUSTRIAL APPLICABILITY

A plant complex for producing steel and a method for operating a plant complex of the type described above can be used in the production of steel.

### LIST OF REFERENCE SIGNS

1=Blast furnace
2=Converter steel works
3=Gas pipeline system
4=Chemical plant
5=Biotechnology plant
6=Biogas plant
7=Coke oven plant
8=Hydrogen generation plant
9=Biosynthesis gas generation plant
10=Power generation plant
11=Operatively controllable gas diverter
12=Mixing device
13=Energy accumulator
14=Plant for gas purification=
15=Plant for gas conditioning
16=Power line network

1.-15. (canceled)

16. A plant complex for producing steel, comprising
a blast furnace for producing pig iron;
a converter steel works for producing crude steel;
a gas pipeline system for gases that occur in the production of pig iron and/or the production of crude steel;
a chemical plant and/or a biotechnology plant which are/is connected to the gas pipeline system, and
a biogas plant which is connected to the gas pipeline system.

17. The plant complex of claim 16 wherein the plant complex further comprises a coke oven plant which is connected to the gas pipeline system.

18. The plant complex of claim 16 wherein the plant complex further comprises at least one hydrogen generation plant which is connected to the gas pipeline system.

19. The plant complex of claim 16 wherein the plant complex further comprises a biosynthesis gas generation plant.

20. The plant complex of claim 16 wherein the plant complex further comprises a power generation plant for electricity, wherein the power generation plant is a gas-turbine power generation plant or a gas-turbine and steam-turbine power generation plant and is operated with a gas that comprises a partial amount of the blast-furnace top gas that occurs in the production of pig iron in the blast furnace and/or a partial amount of the converter gas that occurs in the converter steel works and/or a partial amount of the biogas that occurs in the biogas plant and/or a partial amount of the coke oven gas that occurs in the coke oven plant and/or a partial amount of the biosynthesis gas that occurs in the biosynthesis gas generation plant and/or a partial amount of the hydrogen that occurs in the hydrogen generation plant.

21. The plant complex of claim 16 wherein the gas pipeline system comprises at least one operatively controllable gas diverter for dividing the streams of gas that are fed to the chemical plant and/or the biotechnology plant and/or the hydrogen generation plant and/or the power generation plant and/or the coke oven plant and/or the blast furnace and/or the converter steel works and/or the biosynthesis gas generation plant.

22. The plant complex of claim 16 wherein the gas pipeline system in the flow direction upstream of the at least one operatively controllable gas diverter has at least one mixing device for producing a mixed gas composed of blast-furnace top gas and/or converter gas and/or biogas and/or coke oven gas and/or hydrogen and/or oxygen and/or biosynthesis gas, and in that streams of gas that are fed to the chemical plant and/or the biotechnology plant and/or the hydrogen generation plant and/or the power generation plant and/or the coke oven plant and/or the blast furnace and/or the converter steel works and/or the biosynthesis gas generation plant are able to be controlled by means of the operatively controllable gas diverter.

23. The plant complex of claim 16 wherein the plant complex further comprises an energy accumulator for providing at least part of the electricity requirement of the plant complex.

24. The plant complex of claim 16 wherein the plant complex further comprises a gas purification and/or gas conditioning plant.

25. A method for operating a plant complex including a blast furnace for producing pig iron, a converter steel works for producing crude steel, a biogas plant for producing biogas, a gas pipeline system for gases that occur in the production of pig iron and/or the production of crude steel and/or the production of biogas, and a chemical plant and/or a biotechnology plant, the method comprising:
using at least a partial amount of the biogas that occurs in the biogas plant and a partial amount of the blast-furnace top gas that occurs in the production of pig iron in the blast furnace and/or a partial amount of the converter gas that occurs in the production of crude steel are/is for operating the chemical plant and/or the biotechnology plant and/or the blast furnace for the production of pig iron and/or the converter steel works for the production of crude steel.

26. The method for operating a plant complex of claim 25 wherein the plant complex further comprises a coke oven plant which is connected to the gas pipeline system,
wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant are/is used as useful gas for operating the chemical plant and/or the biotechnology plant and/or the blast furnace for the production of pig iron and/or the converter steel works for the production of crude steel and/or the coke oven plant.

27. The method for operating a plant complex of claim 25 wherein the plant complex further comprises a hydrogen generation plant which is connected to the gas pipeline system,
wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant are/is used as useful gas for operating the chemical plant and/or the biotechnology plant and/or the blast furnace for the production of pig iron and/or the converter steel works for the production of crude steel and/or the coke oven plant and/or the hydrogen generation plant.

28. The method for operating a plant complex of claim 25 wherein the plant complex further additionally comprises a biosynthesis gas generation plant which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant and/or a partial amount of the biosynthesis gas that occurs in the biosynthesis gas generation plant are/is used as useful gas for operating the chemical plant and/or the biotechnology plant and/or the blast furnace for the production of pig iron and/or the converter steel works for the production of crude steel and/or the coke oven plant and/or the hydrogen generation plant and/or the biosynthesis gas generation plant.

29. The method for operating a plant complex of claim 25 wherein the plant complex further comprises a power generation plant which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant and/or a partial amount of the biosynthesis gas that occurs in the biosynthesis gas generation plant are/is used as useful gas for operating the chemical plant and/or the biotechnology plant and/or the blast furnace for the production of pig iron and/or the converter steel works for the production of crude steel and/or the coke oven plant.

30. The method for operating a plant complex of claim 25 wherein the plant complex further comprises a plant for gas purification and/or gas conditioning which is connected to the gas pipeline system, wherein at least a partial amount of the blast-furnace top gas that occurs in the production of pig iron in the blast furnace and/or a partial amount of the converter gas that occurs in the production of crude steel and/or a partial amount of the biogas that occurs in the biogas plant and/or a partial amount of the coke oven gas that occurs in the production of coke in the coke oven plant and/or a partial amount of the hydrogen that occurs in the hydrogen generation plant and/or a partial amount of the biosynthesis gas that occurs in the biosynthesis gas generation plant are/is purified and/or conditioned.
